(19) United States
(12) Patent Application Publication
(10) Pub. No.: US 2004/0139226 A1
(43) Pub. Date: Jul. 15, 2004

(54) Method for assigning an IP address to a network connectable device

(76) Inventors: Dany Margalit, Ramat-Gan (IL); Yanki Margalit, Ramat-Gan (IL)

Correspondence Address: DR. MARK FRIEDMAN LTD., C/O Mr. Bill Polkinghorn, Discovery Dispatch, 9003 Florin Way, Upper Marlboro, MD, 20772, US

(21) Appl. No.: 10/318,105

(22) Filed: Dec. 13, 2002

(51) Int. Cl. G06F 15/16

(52) U.S. Cl. 709/245

(57) ABSTRACT

The present invention is directed to a method for assigning a known IP address to a network connectable device to be installed at a local area network such that no further operations regarding assigning the IP address are required at the installation site, the method comprising: registering a global IP address at a central authority for registering IP addresses; assigning the global IP address to the network connectable device at the manufacturer site; thereby bypassing the need of assigning a local IP address to the network connectable device, at the installation site. According to a preferred embodiment of the invention, setting the registered IP address to the network connectable device is carried out at the manufacturer site.

### FIELD OF THE INVENTION

The present invention relates to the field of network connectable devices. More particularly, the invention relates to a method for installing a network connectable device.

### BACKGROUND OF THE INVENTION

The term Network Connectable Device (NCD) refers herein to a computerized device, connected or to be connected to a network, to be addressed at said network by an IP address.

An example for NCD is the eSafe Gateway, manufactured by Aladdin Knowledge Systems, www.eAladdin.com, which analyses data passing through a network gateway in order to detect viruses or other malicious content presence.

It is in the interest of the manufacturer of a NCD to distribute the NCD as a “turn-key” system, i.e. the procedure of installing a NCD at the installation site (i.e. at the client site) should be as simple as possible, as in Plug-and-Play. However, there is one parameter that should be set at the installation site, which involves inconvenience, and consequently defects the turn-key nature of NCDs—the IP address. Unfortunately, there is no point in setting the IP address of a NCD at the factory, since at the installation site there may be a conflict between the IP address assigned to the NCD and an existing IP address at any specific local network. Therefore this procedure should be carried out at the installation site, where the address conflict can be prevented.

Setting the IP address of a NCD the first time can be carried out at least according to the following ways:

By “physical” input means (e.g. keyboard, mouse, etc.) whenever they are available at the NCD. However, since input means are not required for the regular operation of a NCD, usually NCDs are shipped without input means. Moreover, since NCD doesn't necessary have to be based on a desktop computer, it may not have a convenient user interface, if any.

Connecting the NCD to a standalone computer, usually by a crossed cable connected to their network card, the computer's network card and the NCD's network card. This option is inconvenient, and of course defects the turn-key nature of the NCD.

Automatically, by a DHCP server, if such a server is available at the local network. DHCP, Dynamic Host Configuration Protocol, is a communications protocol by which network administrators can manage and automate the assignment of IP addresses. Consequently, the NCD can be programmed/configured to send a request for IP address to the DHCP server the moment it gets connected to the network, i.e. setting the IP address automatically, without the need of input means or administrator's involvement. However, further to assigning a proper IP address to the NCD, the assigned IP address should still be “announced”. Moreover, IP addresses issued by a DHCP server are temporary, and may be replaced by the DHCP server, contrary to a permanent IP address. Printers usually use this method and in order to be “known”, their manufacturer has to develop a software module for this purpose.

It should be noted that the subject of assigning an IP address has in fact two aspects: the first aspect is the selection of a proper IP address, i.e. an IP address that will not be in conflict with any other IP address. The second aspect is notifying of the selected IP address, since without informing the outside world that a NCD can be addressed by a certain IP address (i.e. to make the IP address “known”), the NCD cannot be accessed, and therefore cannot be re-configured, and so forth.

Fully transparent bridge operating at the data link layer. The data link layer, which is level 2 of the OSI model, deals with linking two points. The next layer, level 3, is the network layer. Thus, installing a NCD between two linked points at layer 2 may be a valid solution to the turn-key problem, however, without having an IP address, the NCD cannot be addressed and thus it cannot be re-configured.

The above mentioned methods are not a complete solution to the problem of rendering a NCD as a turn-key system, since some of these involve inconveniency and some of them may not be available at the installation site.

It is therefore an object of the present invention to provide a method for first time assigning a known IP address to a NCD, which doesn't involve any further operation at the installation site.

It is another object of the present invention to provide a method for first time assigning a known IP address to a NCD, which is more convenient in comparable to some of the methods known in the prior art.

It is a further object of the present invention to provide a method for first time assigning a known IP address to a NCD, which can be carried out in a local network where DHCP is not supported.

It is a still further object of the present invention to provide a method for first time assigning a known IP address to a NCD, which can be carried out only at the manufacturer site, i.e. without the need for further operations at the installation site.

Other objects and advantages of the invention will become apparent as the description proceeds.

### SUMMARY OF THE INVENTION

The present invention is directed to a method for assigning a known IP address to a network connectable device to be installed at a local area network such that no further operations regarding assigning the IP address are required at the installation site, the method comprising: registering a global IP address at a central authority for registering IP addresses; assigning the global IP address to the network connectable device at the manufacturer site; thereby bypassing the need for assigning a local IP address to the network connectable device, at the installation site.

According to a preferred embodiment of the invention, setting the registered IP address to the network connectable device is carried out at the manufacturer site.

The method further comprises assigning a local IP address to the network connectable device after installing the network connectable device at the installation site, thereby enabling the assigning of the global IP address to another network connectable device.

According to one embodiment of the invention, the network connectable device is placed at the gateway of the local area network.

### BRIEF DESCRIPTION OF THE DRAWINGS

The present invention may be better understood in conjunction with the following figures:

FIG. 1 schematically illustrates a general architecture of a system that may be used for operating a NCD.

FIG. 2 schematically illustrates a general architecture of a system that may be used for operating a NCD.

FIG. 3 is a high-level flow chart of installing a network connectable device, according to a preferred embodiment of the invention.

### DETAILED DESCRIPTION OF PREFERRED EMBODIMENTS

The term “local area network” refers herein to a network connected directly or indirectly (i.e. through other network) to the Internet.

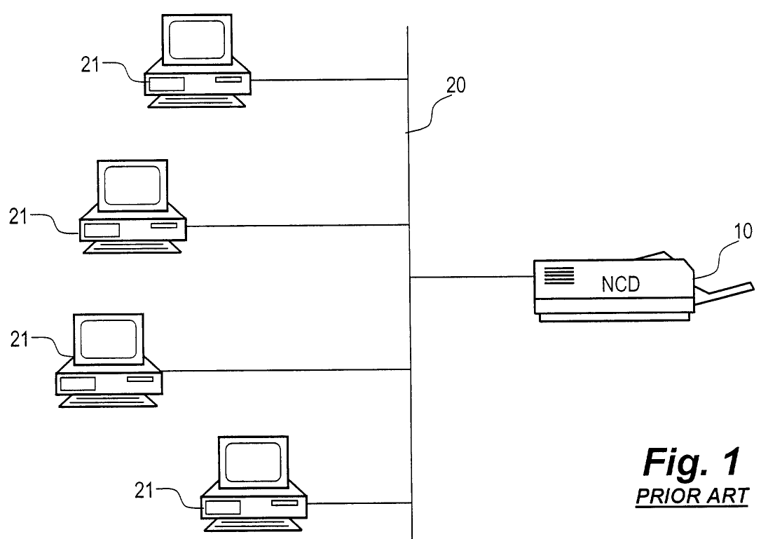

FIG. 1 schematically illustrates a general architecture of a system that may be used for operating a NCD. The computers 21 and the printer 10 are connected to the local area network 20. The printer 10, which is a NCD, has to be configured at least for its IP address on the local area network 20, and if it has no input means, it causes a problem. Actually, the computers 21 and the printer 10 are NCDs, since they are devices connected to the local network 20. Actually, some printers have reduced input means, such as low resolution LCD display and three-button keypad. As mentioned above, the first IP address of network printers is usually assigned by a DHCP server.

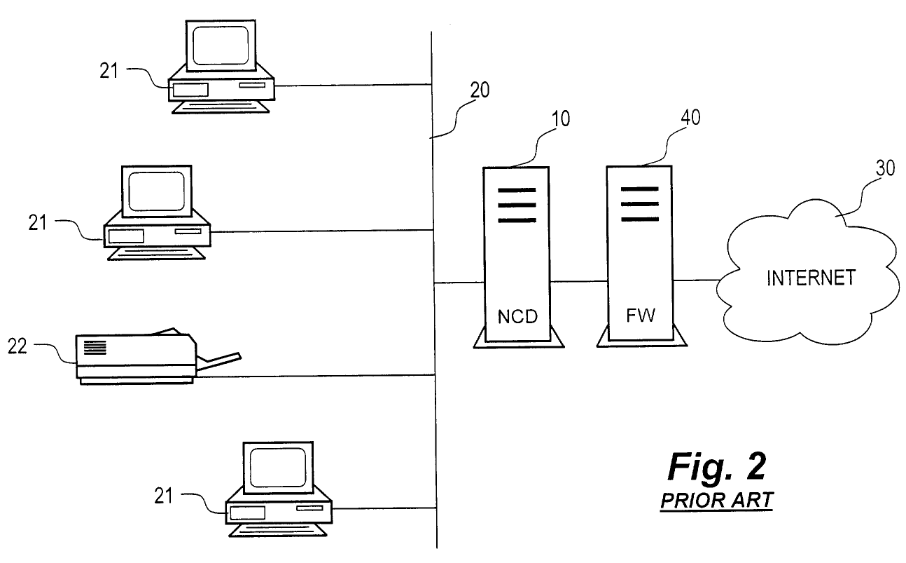

FIG. 2 schematically illustrates a general architecture of a system that may be used for operating a NCD. The computers 21 and the printer 22 are connected to a local area network 20. The firewall 40 is connected to both, the local area network 20 and to the Internet 30. The NCD 10 is connected between the firewall 40 and the elements connected to the network 20 in such a place that the data traffic between the NCDs of the local area network 20 and the firewall 40 is passed through the NCD 10.

It should be noted that at the network topology described in FIG. 2, the order of the NCD 10 and the firewall 40 can be reversed, i.e. the NCD 10 can be the closest to the Internet 30.

According to the prior art, every entity on the Internet has a unique “IP address”, which actually provides a unique identity to this entity. In order to guarantee the uniqueness, the IP address has to be registered in a central authority which deals with this issue, e.g., InterNIC (Internet Network Information Center), ICANN (Internet Corporation of Assigned Names and Numbers), and IANA (Internet Assigned Numbers Authority). Such an organization is referred herein as CIARA (Central Internet Address Registration Authority). CIARA ensures the uniqueness of the IP address, thus the owner of an IP address is guaranteed that no one else will be able to use his IP address.

The present invention deals with the first time assigning an IP address to a NCD. More particularly, the present invention deals with the problem of how to assign an IP address to a NCD, such that no further operation will be required at the installation site for this purpose. The assigned IP address has to be “known”, in order to be addressable by other devices.

According to the present invention, this can be achieved by assigning a “global” IP address (i.e. an Internet registered IP address) to a NCD at the manufacturer site. Thus, the manufacturer gets an IP address from a CIARA, and assigns it as the IP address of the NCD. Since the global IP address is unique and since no local IP address can be in conflict with the global IP address, the stage of assigning a local IP address to the NCD is spared. Assigning a global IP address can be carried out at the manufacturer site, thus sparing the need of setting the IP address of the NCD at the installation site.

The global IP address is actually a resource, and due to the increasing use of the Internet, the resource is exhausting. Moreover, registering and owning an IP address involves some money cost. Therefore, it is in the manufacturer's interest to re-use an IP address assigned to a NCD. However, since the assigned global IP address is used within the local network space, it can be used over and over for other NCDs of this type. The only reason for using another global IP address for an NCD is the possibility that another product of the same manufacturer installed on the same network uses the same IP address. However, since this issue is under the manufacturer's control, he can prevent such a situation.

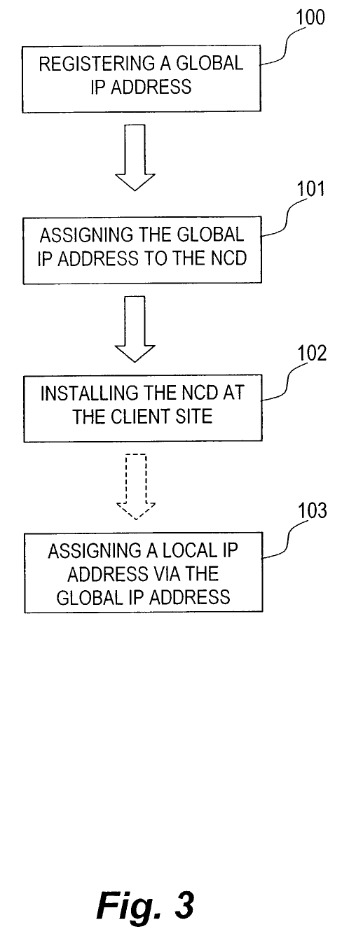

FIG. 3 is a high-level flow chart of installing a network connectable device, according to a preferred embodiment of the invention.

At step 100, a global IP address is registered at a CIARA.

At step 101, the registered IP address is assigned to a NCD, preferably at the manufacturer's site.

At step 102, the NCD is installed at the installation site. Since the global IP address cannot be in conflict with a local IP address, at the installation site no further action is required in this matter.

According to one embodiment of the invention, further steps can be carried out as follows:

At step 103, a local IP address is assigned to the NCD. Since the NCD has already an IP address upon which it can be addressed, a local IP address can be assigned to the NCD, by addressing the NCD via its global IP address. From the moment a local IP address has been assigned to the NCD, the global IP address is actually useless, and therefore it can be used again for the same purpose, or for any other purpose. Therefore, step 104 is optional, not mandatory.

It should be noted that instead of the global IP address, the manufacturer can assign any IP address to the network connectable device, including a group of IP addresses known in the art as “unassigned IP addresses”, which according to the policy of CIARA, they will never be assigned provided by CIARA. However, in this case the network administrator should take this fact into consideration, in order to prevent any conflict with existing local IP addresses.

Those skilled in the art will appreciate that the invention can be embodied by other forms and ways, without losing the scope of the invention. The embodiments described herein should be considered as illustrative and not restrictive.

1. A method for assigning a known IP address to a network connectable device to be installed at a local area network such that no further operations regarding assigning the IP address are required at the installation site, said method comprising:
i)registering a global IP address at a central authority for registering IP addresses;
ii)assigning said global IP address to said network connectable device at said manufacturer site;
thereby bypassing the need of assigning a local IP address to said network connectable device, at the installation site.

2. A method according to claim 1, wherein setting the registered IP address to said network connectable device is carried out at the manufacturer site.

3. A method according to claim 1, further comprising assigning a local IP address to said network connectable device after installing said network connectable device at the installation site, thereby enabling assigning the global IP address to another network connectable device.

4. A method according to claim 1, wherein said network connectable device is placed at the gateway of said local area network.

5. A method according to claim 1, wherein said local area network is a network connected directly or indirectly to the Internet.

6. A method according to claim 1, wherein said global IP address is unassigned by said central authority for registering IP addresses.
